(19) United States
(12) Patent Application Publication
(10) Pub. No.: US 2006/0144056 A1
(43) Pub. Date: Jul. 6, 2006

(54) Display unit for refrigerator

(75) Inventor: Seung Jin Oh, Daegu City (KR)

Correspondence Address: FLESHNER & KIM, LLP, P.O. BOX 221200, CHANTILLY, VA, 20153, US

(73) Assignee: LG Electronics Inc.

(21) Appl. No.: 11/319,461

(22) Filed: Dec. 29, 2005

(30) Foreign Application Priority Data
Jan. 4, 2005 (KR) 2005-0000616

(51) Int. Cl. G01K 13/00; F25B 49/00; F25D 11/02

(52) U.S. Cl. 62/126; 62/129; 62/441

(57) ABSTRACT

The present invention relates to a display unit for a refrigerator. A display unit for a refrigerator of the present invention comprise a casing with at least a portion of a front surface thereof opened to the outside, the casing being received in an accommodating space provided at a certain position of a refrigerator door; a communication unit installed in the casing but exposed to the outside through the opened front surface of the casing to output images to the outside; and a protection panel provided on the front surface of the casing to cover the front surface of the casing including the communication unit. According to the present invention, foreign substances can be prevented from being introduced into the display unit, and the front surface of the display unit can be prevented from being spotted or damaged.

### BACKGROUND OF THE INVENTION

1. Field of Invention

The present invention relates to a refrigerator, and more particularly, to a display unit for a refrigerator which is installed at a front surface of a refrigerator door to receiving operating signals and displaying a variety of information to the outside.

2. Description of the Prior Art

Refrigerators are household appliances for refrigerating or freezing foods and then storing the foods at a fresh state for a long while. Recently, a multi-purpose refrigerator having an additional function of allowing a user to watch television or connect to the Internet in addition to a unique function of storing foods therein has been placed on the market.

FIG. 1 shows an external appearance of a refrigerator mounted with a related art display unit, and FIG. 2 shows a side section of the display unit shown in FIG. 1.

As shown in these figures, a main body 10 of the refrigerator is provided with a certain storage space divided into a refrigerating chamber (not shown) and a freezing chamber (not shown). The freezing and refrigerating chambers are selectively opened or closed by a freezing chamber door 11 and a refrigerating chamber door 13, respectively. The freezing and refrigerating chamber doors 11 and 13 are installed to be pivoted horizontally on both side ends of the main body 10, respectively.

A home bar (not shown) is provided in a portion of the refrigerating chamber door 13. The home bar is selectively opened or closed by a home bar door 15. The home bar door 15 is installed to be pivoted vertically on a specific point on a front surface of the refrigerating chamber door 13.

An accommodating space 17 is provided at a position on a front surface of the freezing chamber door 11. A display unit 20 which will be explained later is received in the accommodating space 17. The accommodating space 17 is formed by depressing a portion on the front surface of the freezing chamber door 11 inward of the refrigerator. The accommodating space 17 takes the shape as a flat box with an open front face to correspond to the shape of the display unit 20.

The display unit 20 is received in the accommodating space 17. Further, the display unit 20 is connected wiredly or wirelessly to a main controller C provided on a top surface of the main body 10. The display unit 20 is supplied with electric power or receives various kinds of electrical signals from the main controller C.

The external appearance of the display unit 20 is defined by a casing. The casing is composed of a front panel 21 for defining a front external appearance thereof and a casing body 22 provided behind the front panel 21. A plurality of openings or holes are formed in the front panel 21. Further, a predetermined installation space is provided within the casing body 22.

A control unit 23 and a communication unit 27 are installed in the installation space of the casing body 22. The control unit 23 and the communication unit 27 are exposed to the outside through the openings and/or holes formed in the front panel 21.

The control unit 23 is to operate the refrigerator. The control unit 23 includes a display part 24 for displaying a variety of information regarding the refrigerator operation to the outside and an input part 25 for receiving a variety of operating signals needed to operate the refrigerator.

The communication unit 27 is to output a variety of images or sounds or connect to the Internet. The communication unit 27 receives signals from the outside to output images or to display information about the Internet to the outside and simultaneously receives operating signals for the image output or information display in touch screen mode.

However, the related art display unit for a refrigerator has the following problems.

As described in detail above, the control unit 23 and the communication unit 27 are exposed to the outside through the openings and/or holes formed in the front panel 21; Therefore, foreign substances may be introduced into the display unit 20 through a gap defined between the control and communication units 23 and 27 and the openings and holes formed in the front panel 21.

Further, in the process of inputting operating signals to the input part 25 of the control unit 23 and the communication unit 27, a user's hand may be brought into direct contact with the front surface of the display unit 20, i.e. the front panel 21, the display part 24 of the control unit 23 or the communication unit 27. Therefore, the front surface of the display unit may be spotted with a hand.

### SUMMARY OF THE INVENTION

Accordingly, the present invention is conceived to solve the aforementioned problem in the prior art. An object of the present invention is to provide a display unit for a refrigerator capable of preventing foreign substances from being introduced into the display unit.

Another object of the present invention is to provide a display unit for a refrigerator configured to prevent spots or stains from occurring during its use.

According to an aspect of the present invention for achieving the objects, there is provided a display unit for a refrigerator, comprising: a casing with at least a portion of a front surface thereof opened to the outside, the casing being received in an accommodating space provided at a certain position of a refrigerator door; a communication unit installed in the casing but exposed to the outside through the opened front surface of the casing to output images to the outside; and a protection panel provided on the front surface of the casing to cover the front surface of the casing including the communication unit.

Preferably, the communication unit receives operating signals regarding the image output in touch screen mode.

The protection panel covers the entire front surface of the casing.

Preferably, the protection panel covers a part of the entire front surface of the casing including the communication unit.

There is further comprising a control unit provided in the casing but exposed to the outside through the opened front surface of the casing to display a variety of information about refrigerator operation to the outside and to receive various kinds of operating signals for the refrigerator operation in touch screen mode.

There is further comprising a control unit provided in the casing but exposed to the outside through the opened front surface of the casing to display a variety of information about refrigerator operation to the outside and to receive various kinds of operating signals for the refrigerator operation and communication unit operation in touch screen mode.

The protection panel covers the entire front surface of the casing.

Preferably, the protection panel covers a part of the entire front surface of the casing including the communication unit and the control unit.

There is further comprising a link mechanism for guiding an inward or outward motion of the display unit and supporting the display unit taken out from the accommodating space to be tiltable at a predetermined angle.

The protection panel is formed of a transparent acrylic resin.

According to a display unit for a refrigerator of the present invention, a gap defined between a front panel and a communication unit and a front surface of the communication unit are covered with a protection panel. Therefore, there are advantages in that it is possible to prevent foreign substances from being introduced into a display unit through the gap between the front panel and the communication unit and also to prevent spots or damages from occurring in the front surface of the display unit.

### BRIEF DESCRIPTION OF THE DRAWINGS

The above and other objectives, features and advantages of the present invention will become apparent from the following description of a preferred embodiment given in conjunction with the accompanying drawings, in which:

FIG. 1 is a perspective view showing an external appearance of a refrigerator mounted with a related art display unit;

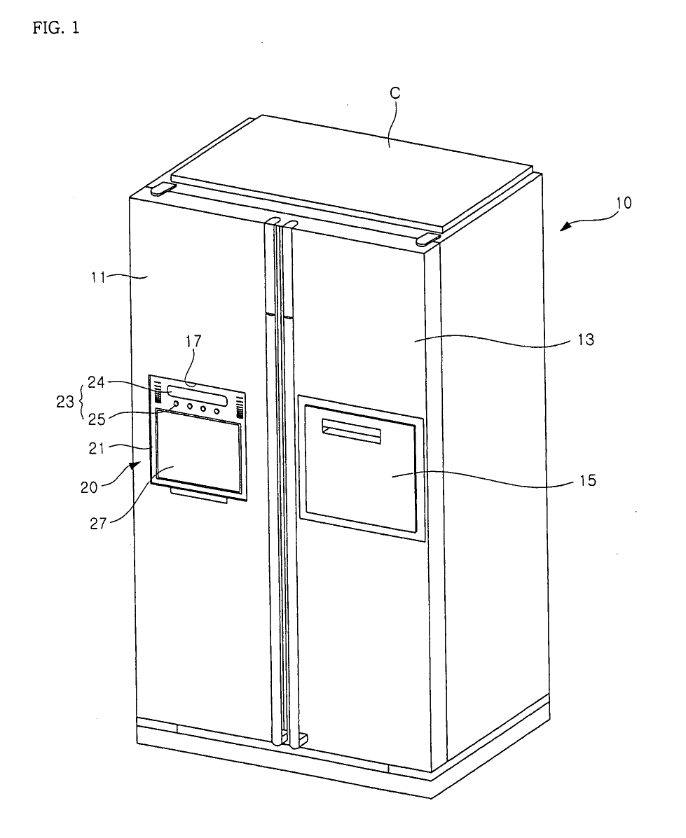

FIG. 2 is a side sectional view of the display unit shown in FIG. 1;

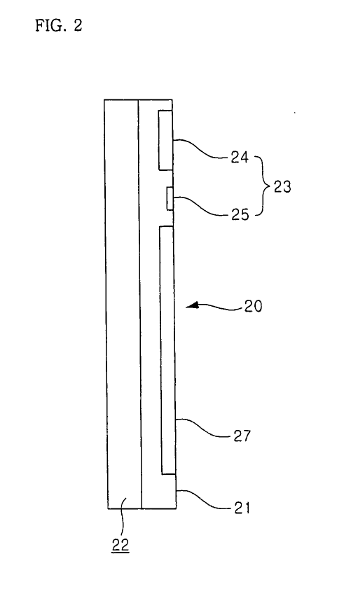

FIG. 3 is a perspective view showing an external appearance of a refrigerator mounted with a display unit according to a preferred embodiment of the present invention; and

FIG. 4 is a side sectional view showing a major portion of the preferred embodiment shown in FIG. 3.

### DETAILED DESCRIPTION OF THE PREFERRED EMBODIMENT

Hereinafter, a preferred embodiment of a display unit for a refrigerator according to the present invention will be described in detail with reference to the accompanying drawings.

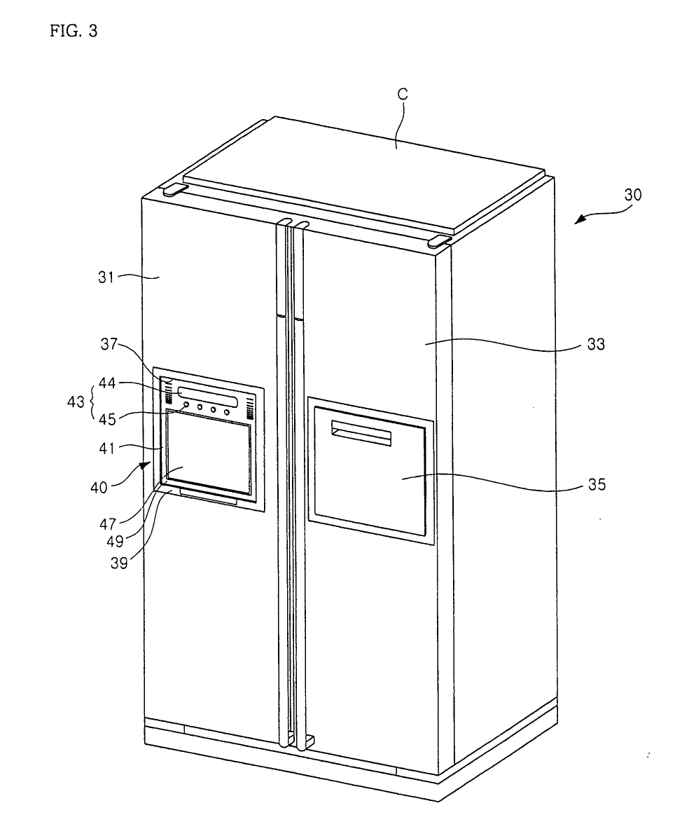

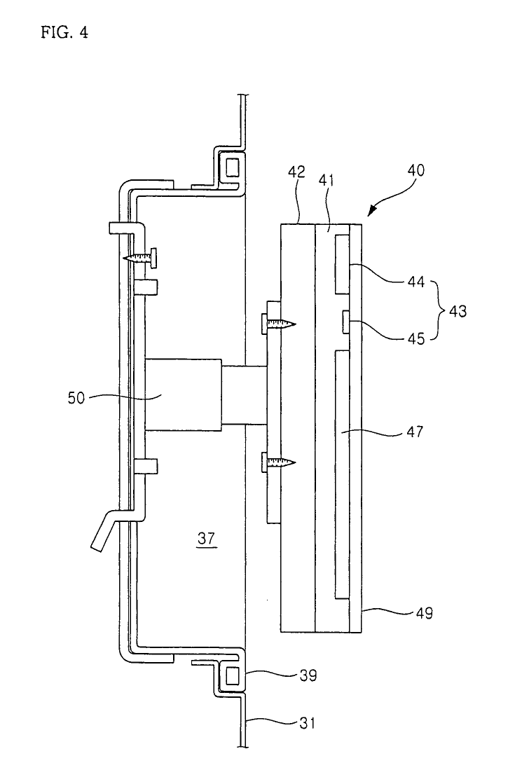

FIG. 3 shows an external appearance of a refrigerator mounted with a display unit according to a preferred embodiment of the present invention, and FIG. 4 shows a side sectional view of the preferred embodiment shown in FIG. 3.

As shown in these figures, a freezing chamber door 31 and a refrigerating chamber door 33 are installed to be pivoted horizontally on both side ends of a main body 30, respectively. A freezing chamber (not shown) and a refrigerating chamber (not shown), which are provided within the interior of the main body 30, are selectively opened or closed by the freezing and refrigerating chamber doors 31 and 33, respectively.

A home bar door 35 is provided at a certain position of a front surface of the refrigerating chamber door 33 such that it can be pivoted vertically on the front surface of the door 33. The home bar 35 serves to selectively open or close a home bar (not shown) provided in the refrigerating chamber door 33.

An accommodating space 37 is provided at a certain position on a front surface of the freezing chamber door 31. The accommodating space 37 is shaped as a flat box with an open front face. The accommodating space 37 may be formed by depressing a portion on the front surface of the freezing chamber door 31 inward of the refrigerator or by using an additional recessed member 39 received in the front surface of the freezing chamber door 31 as shown in FIG. 4.

A display unit 40 is received in the accommodating space 37 to be movable in and out of the accommodating space. The display unit 40 takes the shape of a flat box corresponding to the accommodating space 37. The display unit 40 is supplied with electric power and receives various kinds of electrical signals from a main controller C provided on a top surface of the main body 30. To this end, the display unit 40 is connected wiredly or wirelessly to the main controller C.

A casing that defines an external appearance of the display unit 40 comprises a front panel 41 and a casing body 42. The front panel 41 defines a front external appearance of the display unit 40. A plurality of openings or holes are formed in the front panel 41. The openings and holes formed in the front panel 41 are used to cause a control unit 43 and a communication unit 47, which will be explained later, to be exposed to the outside. A predetermined installation space is also provided within the casing body 42.

The control unit 43 is installed in an upper portion of the installation space of the casing body 42. The control unit 43 includes a display part 44 for displaying a variety of information regarding the refrigerator operation to the outside and an input part 45 for receiving a variety of operating signals needed to operate the refrigerator. The control unit 43 is exposed to the outside through the openings and/or holes formed in the front panel 41. The input part 45 is preferably configured to receive the operating signals in touch screen mode in consideration of a protection panel 49 to be explained later.

The communication unit 47 is installed in a lower portion of the installation space of the casing body 42 corresponding to a position below the control unit 43. The communication unit 47 is also exposed to the outside through the openings and/or holes formed in the front panel 41. The communication unit 47 is used to output a variety of images or sounds, to display information about the Internet to the outside, and to receive operating signals for the image or sound output or information display. The communication unit 47 also receives the operating signals in the same touch screen mode as the input unit 45. As an example of the communication unit 47, there can be provided a television kit for allowing a use to watch television, a tablet computer for connecting to the Internet, or the like.

The protection panel 49 is attached to a surface of the front panel 41 corresponding to a front surface of the display unit 40. The protection panel 49 serves to cover the surface of the front panel 41 including the control unit 43 and the communication unit 47. To this end, the protection panel 49 takes the shape of a rectangular plate corresponding to the front panel 41.

At least a portion of the protection panel 49 is formed of a transparent material such that the display part 44 and the communication unit 47 can be identified from the outside. For example, the protection panel 49 may be formed of a transparent acrylic resin. Further, the protection panel 49 is sized such that it can cover at least the control unit 43 and communication unit 47 and a portion of the front panel 41 adjacent to the control and communication units.

Furthermore, a link mechanism 50 is installed on a front surface of the recessed member 39 corresponding to the front surface of accommodating space 37. The link mechanism 50 serves to guide the inward or outward motion of the display unit 40. Further, the link mechanism 50 serves to support the display unit 40 such that the display unit can be tilted at a predetermined angle in a horizontal or vertical direction. Since the constitution of the link mechanism has no significant correlation with the present invention, the detailed description thereof will be omitted herein.

Hereinafter, the operation of a display unit for a refrigerator according to the present invention so configured will be described more in detail.

First, a process of fabricating and installing the display unit according to the preferred embodiment of the present invention will be explained.

The control unit 43 and the communication unit 47 are installed in the installation space of the casing body 42. Then, the front panel 41 is installed on a front face of the casing body 42. At this time, the control unit 43 and the communication unit 47 are exposed to the outside through the openings and/or holes formed in the front panel 41.

In addition, a rear surface of the protection panel 49 is brought into close contact with the front surface of the front panel 41. At this time, an adhesive is beforehand prepared on the rear surface of the protection panel 49. Therefore, if the protection panel 49 is attached to the surface of the front panel 41, the fabrication of the display unit 40 is finished.

However, it is not always necessary to use an adhesive when the protection panel 49 is attached to the front panel 41. For example, it is possible to attach the protection panel 49 to the front panel 41 by using at least one fixing screw (not shown) which is penetrated into the protection panel 49 and then fixed to the front panel 41 in a state where the protection panel 49 has been brought into close contact with the surface of the front panel 41.

Further, the display unit 40 is coupled to the link mechanism 50 in such a manner that one end of the link mechanism 50 is fixed to front surface of the accommodating space 37 while the other end thereof is coupled to the display unit 40. Therefore, the display unit 40 can be moved in and out of the accommodating space 37.

Next, a process of using the display unit according to the preferred embodiment of the present invention will be described more in detail.

First, a user grips the display unit 40 with his/her hand and pulls the display unit 40 in front of the accommodating space 37. Thus, the display unit 40 is taken out from the accommodating space 37. Then, the user may tilt and fix the display unit 40 at a desired angle in consideration of his/her own current position.

If the position of the display unit 40 is fixed, the user can input operating signals to the input part 45 of the control unit 43 to control the operation of the refrigerator. Then, the user can confirm various kinds of information about the refrigerator operation displayed on the display part 44 of the control unit 43.

Further, the display unit 40 may be used to output images or sounds or connect to the Internet. To this end, the user inputs the operating signals into the communication unit 47, which in turn outputs the images or sounds or display a variety of information via the Internet in response to the inputted operating signals.

In the meantime, the protection panel 49 is attached to the front surface of the display unit 40, i.e. the surface of the front panel 41. Therefore, it is possible to prevent foreign substances form being introduced into the display unit through a gap between the opening and/or holes formed on the front panel 41 and the control or communication unit 43 or 47. Further, since a user's finger is substantially brought into contact with the protection panel 49 instead of the display unit 40 when the user intends to put in or take out the display unit or to input the various kinds of operating signals, it is possible to prevent the front surface of the display unit 40 from being spotted or stained.

According to a display unit for a refrigerator of the present invention configured as described above, the following effects can be expected.

First, a protection panel can prevent foreign substances from being introduced into the display panel. Thus, operating reliability and durability of a product can be ensured.

Further, an entire front surface of the display unit is substantially protected by the protection panel. Therefore, since the hand of a user is brought into contact with the protection panel rather than the display panel when the user pulls or pushes the display unit or inputs operating signals, the display unit can be prevented from being stained or spotted and thus the product can be more conveniently employed.

It will be apparent that those skilled in the art can make various modifications and changes within the scope of the fundamental technical spirit of the present invention. Therefore, the scope of the present invention should be construed on the basis of the appended claims.

1. A display unit for a refrigerator, comprising:
a casing with at least a portion of a front surface thereof opened to the outside, the casing being received in an accommodating space provided at a certain position of a refrigerator door;
a communication unit installed in the casing but exposed to the outside through the opened front surface of the casing to output images to the outside; and
a protection panel provided on the front surface of the casing to cover the front surface of the casing including the communication unit.

2. The display unit as claimed in claim 1, wherein the communication unit receives operating signals regarding the image output in touch screen mode.

3. The display unit as claimed in claim 2, wherein the protection panel covers the entire front surface of the casing.

4. The display unit as claimed in claim 2, wherein the protection panel covers a part of the entire front surface of the casing including the communication unit.

5. The display unit as claimed in claim 1, further comprising a control unit provided in the casing but exposed to the outside through the opened front surface of the casing to display a variety of information about refrigerator operation to the outside and to receive various kinds of operating signals for the refrigerator operation in touch screen mode.

6. The display unit as claimed in claim 5, wherein the protection panel covers the entire front surface of the casing.

7. The display unit as claimed in claim 5, wherein the protection panel covers a part of the entire front surface of the casing including the communication unit and the control unit.

8. The display unit as claimed in claim 1, further comprising a control unit provided in the casing but exposed to the outside through the opened front surface of the casing to display a variety of information about refrigerator operation to the outside and to receive various kinds of operating signals for the refrigerator operation and communication unit operation in touch screen mode.

9. The display unit as claimed in claim 8, wherein the protection panel covers the entire front surface of the casing.

10. The display unit as claimed in claim 8, wherein the protection panel covers a part of the entire front surface of the casing including the communication unit and the control unit.

11. The display unit as claimed in claim 1, further comprising a link mechanism for guiding an inward or outward motion of the display unit and supporting the display unit taken out from the accommodating space to be tiltable at a predetermined angle.

12. The display unit as claimed in claims 11, wherein the protection panel is formed of a transparent acrylic resin.
